(19) United States
(12) Patent Application Publication
(10) Pub. No.: US 2014/0214472 A1
(43) Pub. Date: Jul. 31, 2014

(54) SYSTEMS, METHODS, AND DEVICES FOR ANALYZING A ROUTE USING A GEOGRAPHIC INFORMATION SYSTEM

(71) Applicants: Joel Sewell, Santa Ana, CA (US); Robert Segawa, Tustin, CA (US); Bob Perham, Huntington Beach, CA (US); Yeou Tsan Allen Tsai, Irvine, CA (US); Nagendra Putti, Redlands, CA (US)

(72) Inventors: Joel Sewell, Santa Ana, CA (US); Robert Segawa, Tustin, CA (US); Bob Perham, Huntington Beach, CA (US); Yeou Tsan Allen Tsai, Irvine, CA (US); Nagendra Putti, Redlands, CA (US)

(73) Assignee: Paragon Partners Ltd., Huntington Beach, CA (US)

(21) Appl. No.: 13/840,213

(22) Filed: Mar. 15, 2013

Related U.S. Application Data
(60) Provisional application No. 61/759,380, filed on Jan. 31, 2013.

(51) Int. Cl. G06Q 10/06

(52) U.S. Cl. CPC G06Q 10/06313
USPC 705/7.23

(57) ABSTRACT

Systems, methods and devices for analyzing a route using a geographic information system (GIS) are disclosed. Such systems, methods, and devices may include rendering a map, plotting a route on such a map. GIS software identifies route features and land parcels along the route. Further, aspects of the present disclosure describe performing cost analysis, route impact, analysis and environment analysis for the route using GIS software and processing route feature and land parcel information stored across different database modules and information repositories.

### CROSS-REFERENCE TO RELATED APPLICATIONS

The present application claims priority under the laws and rules of the United States, including 35 USC §120, to U.S. Patent Application No. 61/759,380. The contents of U.S. Patent Application No. 61/759,380 are herein incorporated by reference in its entirety.

### FIELD OF THE INVENTION

The field of the invention generally relates to geographic information systems. Particularly, the field of the invention relates to analyzing a route plotted on a map using a geographic information system (GIS).

### BACKGROUND

Infrastructure development and improvement in various industries (e.g. municipal works, roads and bridges, electrical grid, petroleum and gas, etc.) may require the acquisition of land by a municipality or company. However, prior to the acquisition of such land for the route of the infrastructure development/improvement, a municipality or company may analyze the route to determine land appraisal and acquisition costs, route impact to the surface and subsurface of the land, and land use/environmental impact of the route. Traditionally, each aspect of the route analysis includes on-site appraisal, geology/scientific/technical study, and/or environment analysis of each route feature (e.g. waterway, mountain, valley, geographic or geological feature etc.) or parcel of land along the route.

### BRIEF DESCRIPTION OF THE SEVERAL VIEWS OF THE DRAWINGS

The accompanying drawings, which are incorporated in and constitute part of this specification, illustrate embodiments of the invention and together with the description serve to explain the principles of the present disclosure. The embodiments illustrated herein are presented as examples, it being understood, however, that the invention is not limited to the precise arrangements and instrumentalities shown, wherein:

FIG. 1 shows example routes for an exemplary infrastructure development between two geographic locations;

FIG. 2 is an example flowchart for an example method for analyzing a route using a geographic information system;

FIG. 3 is an example functional diagram for an example system for analyzing a route using a geographic information system;

FIG. 4 is an example functional block diagram for an example GIS server used for analyzing a route;

FIG. 5 is an example functional block diagram for an example database module coupled to a GIS server used for analyzing a route;

FIGS. 6-8 are example flowcharts each for an example method for analyzing a route using a geographic information system;

FIG. 9 is an example flowchart for an example method to view a selected parcel of interest along a route;

FIG. 10 is an example functional block diagram of an example functional architectural model for analyzing a route.

### DETAILED DESCRIPTION

The illustrative embodiments described in the detailed description, drawings, and claims are not meant to be limiting. Other embodiments may be utilized, and other changes may be made, without departing from the scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

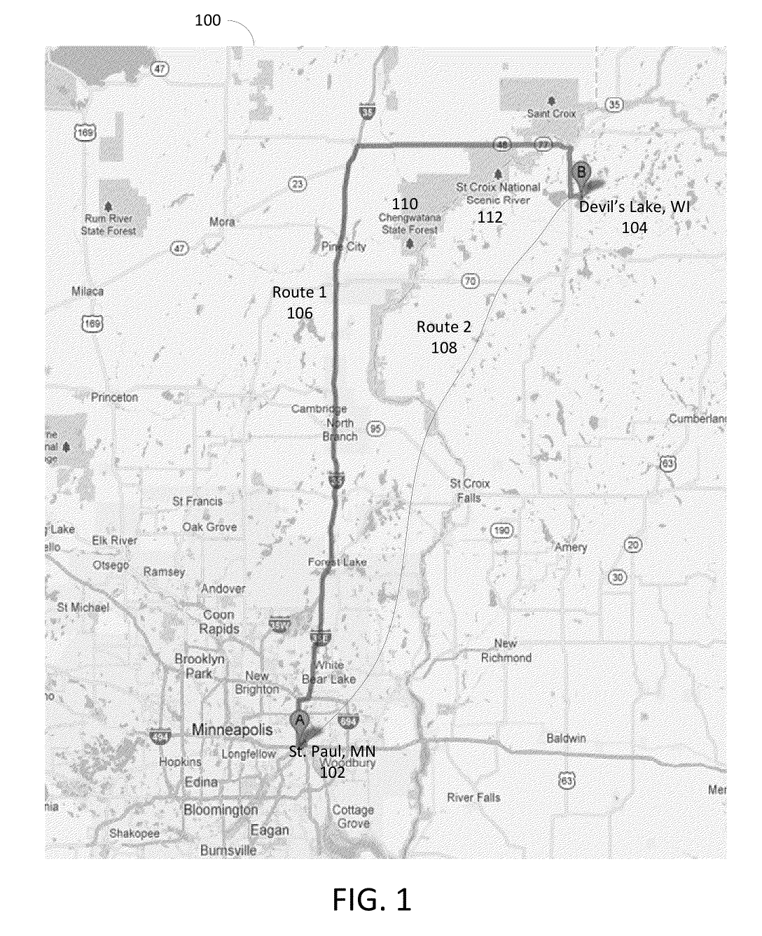

FIG. 1 shows two example routes (106 and 108) on a map 100 for an exemplary infrastructure development project between two geographic locations (102 and 104). For example, the routes (106 and 108) indicated on the map 100 may be for an overhead electrical line project coordinated between St. Paul, Minn. and Devil's Lake, Wis. The need for additional electrical power to the region may be due to the rise in popularity of Devil's Lake as a tourist destination. The developer for the project selects two different routes (106 and 108). Route 1 (106) is along an interstate highway and local roads while Route 2 (108) is along the countryside crossing a river 112 and state park 110. The developer for the project may want to understand the difference in terms of land appraisal and acquisition costs, route impact to the surface and subsurface of the land, and land use/environmental impact between route 1 (106) and route 2 (108).

Route features and land parcels may be used to assess land appraisal and acquisition costs as well as analyze route impact and land use/environmental impact. Route features may include, but are not limited to, geological features such as e.g. oil/gas reserve, arable land, forest preserve, rocks and minerals, land elevation, soil, etc.) as well as infrastructural features such as highways, roads, bridges, airports, public transportation, etc. However, a route feature may include any feature that may impact a route in its land acquisition cost, development cost, and/or environmental analysis. Many of the route features may be stored in a database module of a GIS system as GIS layer data. For example, geological route features that are on the surface of the land (e.g. terrain, elevation, soil, etc.) may be stored in one GIS data layer. Conversely, geological route features below the surface of the land (e.g. underground water supply, rocks and minerals, etc.) may be stored in another GIS data layer. Further, infrastructural route features on the land surface (e.g. highway, public transportation, bridges, etc.) may be stored in separate GIS data layer while infrastructural route features below the land surface (e.g. pipelines, water and sewage systems, etc.) may be stored in a different GIS data layer. Moreover, the database module of the GIS system may store land parcel information such as address and tax identification information that may be used to find appraisal and cost of the associated land parcel. Further, the database module be store other information in datasets that may assist in calculating the land acquisition cost as well as analyzing route and land use/environment impact.

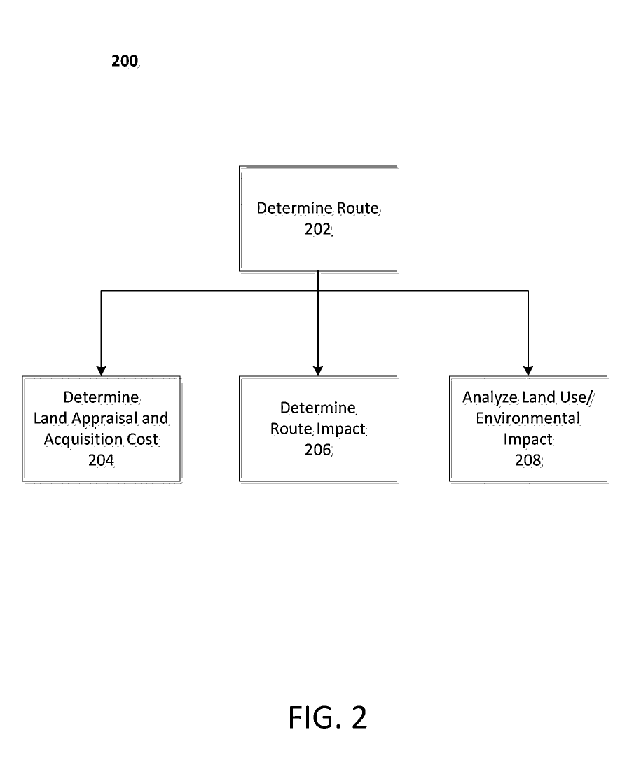

FIG. 2 is an example flowchart for an example method 200 for analyzing a route using a geographic information system. The example method may include determining a route, as shown in block 202. The present disclosure describes one or more modules that may be used to determine a route. For example, a user may use such modules in conjunction with a GIS software platform. A user may request rendering of a map of a geographical area and then use a route drawing module to plot a route of a future infrastructure development project on the map.

Another aspect of the example method 200 may include determining land appraisal and land acquisition costs of the land along the route, as shown in block 204. Traditionally, land appraisal is determined through on-site inspection of each parcel of land along a route for an infrastructure development project. Further, cost of acquisition of each parcel of land along the route was determined through an analysis of recent sales of comparable land parcels in the market. Further, referring to FIG. 1, a geology or engineering study may have been conducted in the field to determine the cost of crossing a river 112 or a densely forested state park 110 along a route 108. The present disclosure describes systems, methods, and devices that determine, dynamically and/or in real-time, at least a portion if not all the costs of acquiring the land parcels along a route as well as the costs of traversing certain route features such as a river 112 or a state park 110.

A further aspect of the example method 200 may include determining route impact, as shown in block 206. Conventionally, route impact analysis is conducted through manual research and analysis. For example, analytical teams would research and examine GIS layer data that include land surface and subsurface route features. Thereafter, such analytical teams may determine the construction schedule, permits required, and labor costs for the infrastructure development along the route. The present disclosure describes systems, methods, and devices that provide, dynamically and/or in real-time, a route impact analysis report using GIS layer data and other GIS data sets.

An additional aspect of the example method 200 may include determining the land use/environmental impact analysis of the route, as show in block 208. Land use/environment impact analysis is conventionally performed by manually analyzing GIS layer data of the land surface and land subsurface layers along the route. For example, GIS layer data may be analyzed to determine whether a route traverses an underground water supply or whether there were other geological features that the route may impact (e.g. oil/gas reserve, arable land, forest preserve, etc.). Further, there may be man-made infrastructure (e.g. highways, roads, bridges, airports, etc.) that may be impacted by the route. The present disclosure describes systems, methods, and devices that provide, dynamically and/or in real-time, a land use/environment analysis of traversing certain route features such as oil/gas reserve, arable land, forest preserve as well as highways, roads, bridges, airports, and other infrastructural route features. The land use/environment analysis may also analyze other route features that may be affected.

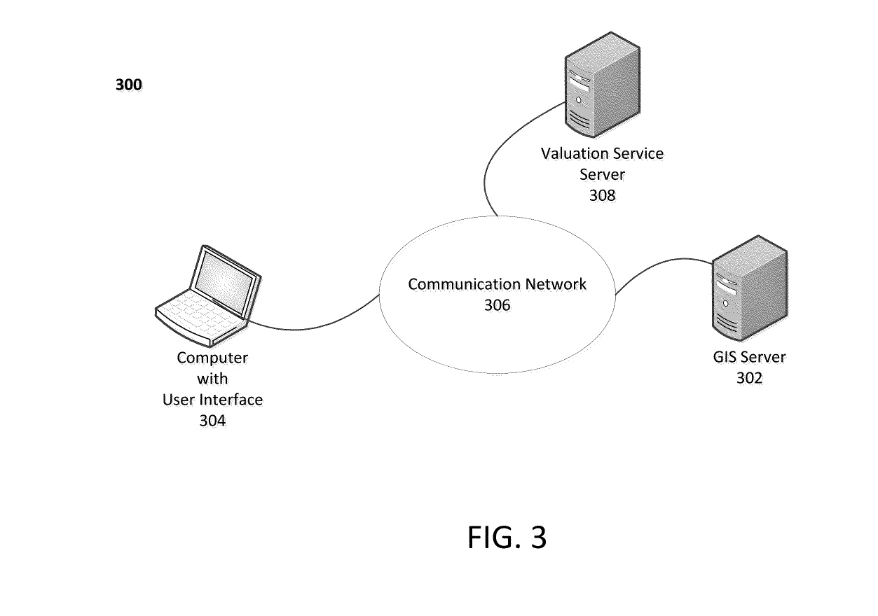

FIG. 3 is an example functional diagram for an example system 300 for analyzing a route using a geographic information system (GIS). The example system 300 includes a GIS server 302 coupled to a user computer 304 with a user interface over a communication network 306. Further, the example system 300 includes one or more valuation service servers 308. A GIS server includes one or more modules and tools that assist a user in determining a route for a particular (infrastructure) development project. Such modules and tools may include a map rendering module and a route drawing tool.

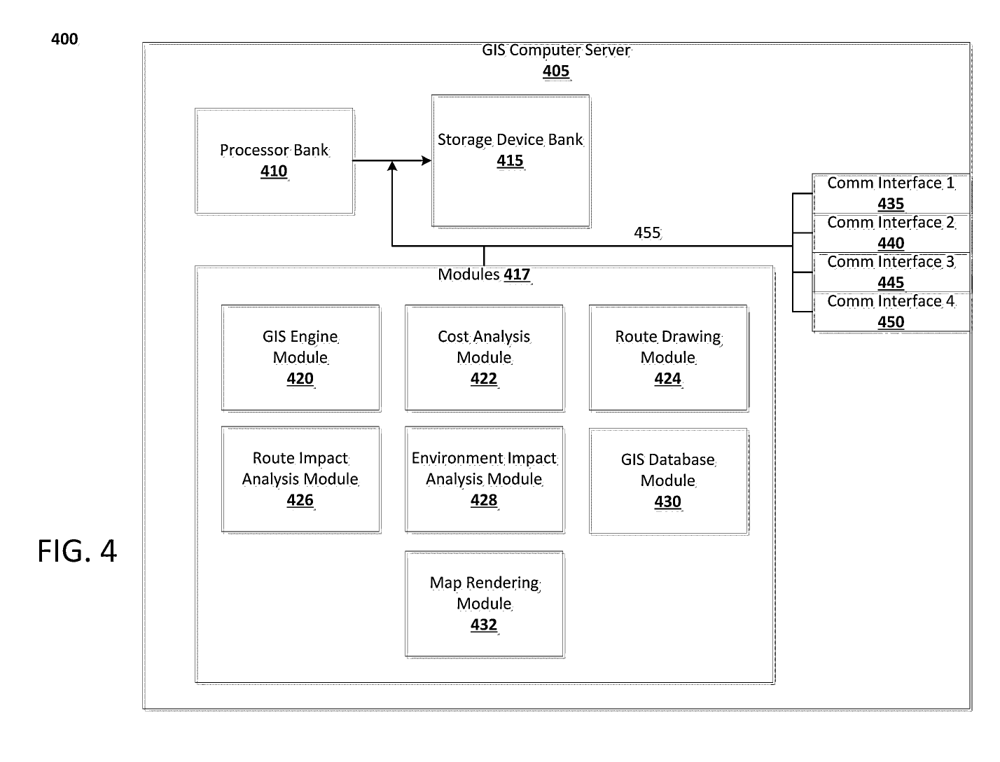

Further modules may include a cost analysis module that assesses land appraisal and land acquisition costs for the route. Additional modules may include a route impact analysis module that determines construction schedule, permits required, and labor costs for the infrastructure development along the route. Other modules may include an environment impact analysis module analyzes GIS layer data or GIS datasets of the land surface and land subsurface layers along the route. For example, GIS layer data may be analyzed to determine whether a route traverses an underground water supply or whether there were other geological features that the route may impact (e.g. oil/gas reserve, arable land, forest preserve, etc.). Further, there may be man-made infrastructure (e.g. highways, roads, bridges, airports, etc.) that may be impacted by the route. The land use/environment analysis module may also analyze other route features that may be affected. The GIS server may include a database module storing GIS layer data and data sets. Such modules are described in the present disclosure when describing FIG. 4. A database module storing GIS layer data as well as GIS and other pre-stored datasets is described that may be used by the cost analysis, route impact analysis, and environment analysis modules.

A user may use modules on a user computer 304 to conduct a cost analysis, route impact analysis, and/or environment analysis through a user interface (e.g. a user interface that is built by a user interface builder module and presented visually via http protocols to a web browser). Prior to accessing such modules, the user may access map rendering modules and a route drawing module from the GIS server to draw a route for a (e.g., infrastructure) development project on a map of a geographical area display on the user interface. After drawing the route and entering route parameters such as width and depth of the route as well as the width of the construction zone through the user interface, the user may access the analytical modules, which may be part of the GIS server 302, to determine land acquisition costs, route impact analysis, and land use/environmental analysis.

The analytical modules (e.g. cost analysis, route impact analysis, and environment analysis modules) may access data not only stored in the database module coupled to the GIS server but also access data from one or more valuation service servers. A valuation service provides land values based on an address or tax identifier of a parcel of land (e.g. Zillow, Core Logic). Further, the analytical modules may perform web-scraping functions on various web servers to gather data to conduct their respective analysis. Thus, the cost analysis module may retrieve an address or tax identifier of one or more parcels of land along the route from the database module coupled to the GIS server. Further, the cost analysis module may query one or more valuation service servers for values of each of the parcels of land.

FIG. 4 is an example functional block diagram for an example GIS server 405 used for analyzing a route. Such a computer server 405 may be used in a network shown in FIG. 3. The computer server 405 may include several different components such as a processor bank 410, storage device bank 415, one or more software applications, that when executed by a processor from specifically-configured module devices 417, and one or more communication interfaces (435-450). The processor bank 410 may include one or more processors that may be co-located with each other or may be located in different parts of the computer server 405. The storage device bank 415 may include one or more storage devices. Types of storage devices may include memory devices, electronic memory, optical memory, and removable storage media. The one or more modules 417 may include a GIS engine module 420, cost analysis module 422, route drawing module 424, route impact analysis module 426, environment impact analysis module 428, GIS database module 430, and a map rendering module 432. The modules 417 may be implemented by the one or more processors in the processor bank 410.

The GIS engine module 420 is software, combined with appropriate hardware as described herein, that generates the GIS information that may be displayed on a user interface of a user computer such as displaying a map, generating and retrieving data sets that describe route features and provides the map manipulation tools such as the route drawing module 424 and map rendering module 432. Further, the GIS engine module 420 interacts with the GIS database module 430 to retrieve GIS layer data, GIS datasets, route information, and land parcel information to provide to the analytical modules (422, 424, and 428).

In one embodiment of the present disclosure, a user at a user computer may, by way of a user interface, request to display a map on the user interface of the user computer to draw a route for an infrastructure development project. The GIS server may receive map display instructions from a user interface over one of the communication interfaces (435-450). The GIS engine module may retrieve a map from the GIS database module 430 and the map rendering module 432 may cause the map to display on the user interface. Further, the GIS server may receive route display instructions for a route for the infrastructure development project. The GIS engine module 420 in conjunction with the route drawing module 424 causes the route to be displayed on the user interface of the user computer. In addition, the user may input route parameters such as the width of the route and depth of the infrastructure development project underneath the surface of the land. Moreover, the user may input the width of a construction zone for the infrastructure development project. The GIS server 405, or one or modules thereof, receives and processes such route parameters to, inter alia, identify route features and land parcels along the route.

Route features may include, but are not limited to, geological features such as e.g. oil/gas reserve, arable land, forest preserve, rocks and minerals, land elevation, soil, etc.) as well as infrastructural features such as highways, roads, bridges, airports, public transportation, etc. However, a route feature may include any feature that may impact a route in its land acquisition cost, development cost, and/or environmental analysis. Further, the GIS engine module 420 retrieves route feature information and land parcel information from the GIS database module by analyzing GIS layer data and GIS datasets. Such route feature information and land parcel information may be used by the analysis modules (422, 424, and 428).

In a further embodiment, a user may request a cost analysis of the route for an infrastructure development project that includes land appraisal and land acquisition costs for parcels of land along the route. In addition, the cost analysis may include the cost of traversing certain route features (e.g. river and waterways, etc.). The GIS server 405 receives instructions to perform a cost analysis of the route. The cost analysis module 422, upon receiving the instructions, may query the GIS engine module for route feature information and land parcel information of the identified route features and land parcels along the route. Further, the cost analysis module may query one or more valuation service servers to determine the cost associated with one or more route features and the one or more land parcels based on the route feature information and land parcel information.

For example, route feature information may be the type of route feature identified. (e.g. river). Further data stored in the database module 430 or in the valuation service servers may show that the cost of traversing the river for the infrastructure development project may be $1 million and is included in the cost analysis. In addition, land parcel information may include the land parcel address or tax identification number. The cost analysis module 422 may query the GIS database module 430 or valuation service servers as well as scrape web servers or other information repositories to find comparable sales information for land parcels along the route to determine land acquisition costs. Moreover, the cost analysis module 422 calculates the cost of the route based on the cost associated with the one or more route features and one or more land parcels. Such a cost analysis may be provided to the user interface as a cost analysis report.

In another embodiment, a user may request a route impact analysis for an infrastructure development project. Route impact analysis includes determining the construction schedule, permits required, and labor costs for the infrastructure development along the route using GIS layer data and other GIS data sets. In such an embodiment the GIS server may receive route impact instructions from the user interface. The route impact analysis module 426 may process route feature information to determine the route impact of each route feature. Further, the route impact analysis module 426 provides a route impact analysis report that includes the route impact for each route feature. For example, if the route traverses bridges and highways (i.e. route features) in a certain urban area, the route impact analysis module 426 processes the route feature information to determine that the user would be required to obtain construction permits and render the associated permit costs.

In additional embodiments, a user may request a land use or environment impact analysis for an infrastructure development project. Land use/environment analysis includes analyzing GIS layer data of the land surface and land subsurface along the route. For example, GIS layer data may be analyzed to determine whether a route traverses an underground water supply or whether there are other geological features that the route may impact (e.g. oil/gas reserve, arable land, forest preserve, etc.). Further, there may be man-made infrastructure (e.g. highways, roads, bridges, airports, etc.) that may be impacted by the route. The land use/environment analysis module may also analyze other route features that may be affected. The GIS server 405 may receive one or more environment impact instructions from the user interface module to provide an environment impact analysis report. The environment impact analysis module 428 may analyze route feature information to determine an environment impact of each route feature. Further, the environment impact analysis module may provide an environment impact analysis report to the user interface that includes the environment impact for each route feature.

Each of the communication interfaces (435-450) may be software or hardware associated in communicating to other devices. The communication interfaces (235-250) may be of different types that include a user interface, USB, Ethernet, WiFi, WiMax, wireless, optical, cellular, or any other communication interface coupled to a communication network. One or more of the communication interfaces (435-450) may be coupled to a user interface known in the art.

An intra-device communication link 455 between the processor bank 410, storage device bank 415, modules 417, and communication interfaces (430-445) may be one of several types that include a bus or other communication mechanism.

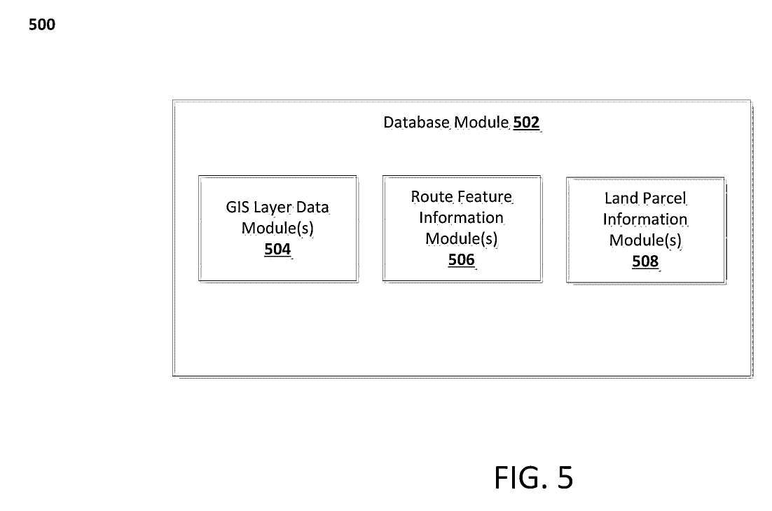

FIG. 5 is an example functional block diagram for an example database module 502 coupled to a GIS server used for analyzing a route. The database module 502 may be the GIS database module 430 shown in FIG. 4. The database module 502 may include GIS layer data 504, route feature information 506, and land parcel information 508. GIS layer data may include, for example, geological route features that are on the land (e.g. terrain, elevation, soil, etc.) stored in one GIS layer. Conversely, geological route features underneath the land (e.g. underground water supply, rocks and minerals, etc.) may be stored in another GIS layer. Further, infrastructural route features on land (e.g. highway, public transportation, bridges, etc.) may be stored in separate GIS layer while infrastructural route features underneath the land (e.g. pipelines, water and sewage systems, etc.) may be stored in a different GIS layer. In addition, the route feature information 506 may include costs to traverse certain route features. For example, a river (i.e. route feature) may cost $1 million to traverse for a certain type of infrastructure development project. Moreover, the database module 502 may store land parcel information 508 such as address or tax identification information that may be used to find appraisal and cost of the associated land parcel as well as other information in data sets that may assist in calculating the land acquisition cost as well as route and land use/environment impact.

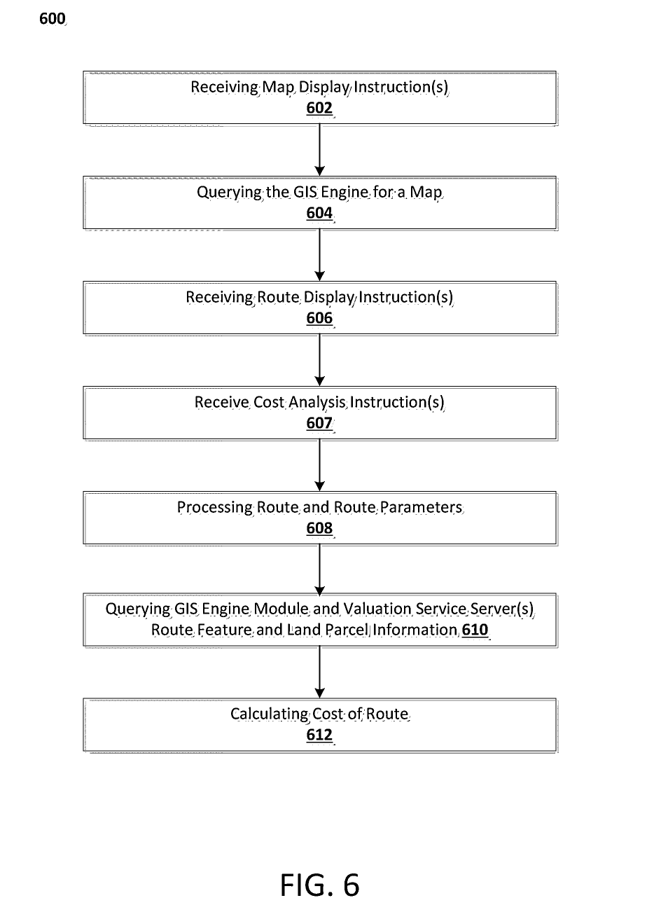

FIG. 6 is an example flowchart for an example method 600 for analyzing a route using a geographic information system. The example method 600 includes receiving one or more map display instructions from a user interface on user computer to display a map on the user interface, as shown in block 602. The map may be rendered using a GIS engine module and a map rendering module implemented as part of a GIS server. The example method further includes requesting, by the GIS server, the GIS engine module to cause the map to be displayed on the user interface of the user computer, as shown in block 604. The example method 600 further includes receiving, by the GIS server, one or more route display instructions from the user interface to cause to display a route on the map on the user interface by a route drawing module, as shown in block 606. Thus, for example, a user may draw or plot a route for an infrastructure development project on a map. Moreover, the example method 600 includes receiving, by the GIS server, one or more cost analysis instructions to determine the cost for the route from the user interface, as shown in block 607. In addition, the example method 600 includes processing, by the GIS server, the route on the map and one or more route parameters using the cost analysis module to determine one or more route features and one or more land parcels, as shown in block 608. Route parameters may include the width and depth of the route. The example method 600 also includes querying, by the GIS server, the GIS engine module for route feature information and land parcel information as well as querying one or more valuation service servers to determine the cost of traversing the one or more route features and the one or more land parcels based on the route feature information and land parcel information, as shown in block 610. Route features may include, but are not limited to, geological features such as e.g. oil/gas reserve, arable land, forest preserve, rocks and minerals, land elevation, soil, etc.) as well as infrastructural features such as highways, roads, bridges, airports, public transportation, etc. However, a route feature may include any feature that may impact a route in its land acquisition cost, development cost, and/or environmental analysis. Route feature information may include the cost of traversing a route feature for a different types infrastructure projects. Land parcel information may include land parcel address or tax identification information as well comparable sales information. Route feature information and land parcel information may be retrieved from a GIS database module by analyzing GIS layer data and GIS datasets as well as by querying valuation service servers and scraping web servers. Moreover, the example method 600 further includes calculating the cost of the route based on the cost of traversing the one or more route features and one or more land parcels to provide a cost analysis of the route to the user interface on the user computer, as shown in block 612.

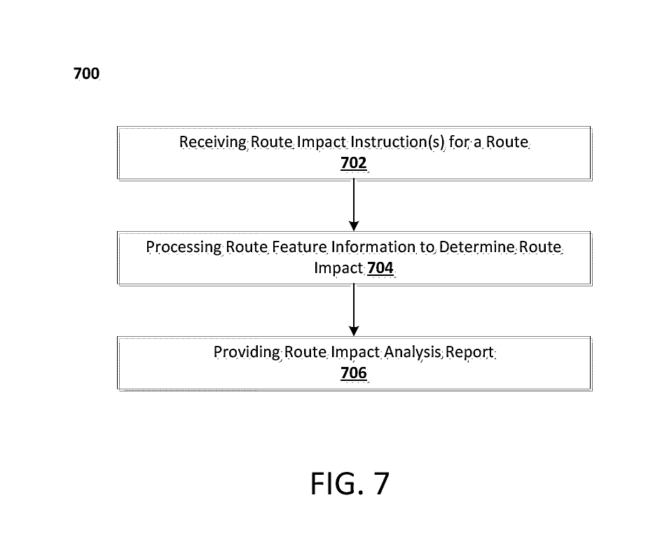

FIG. 7 is an example flowchart for an example method 700 for analyzing the route impact of a route. A user may request a route impact analysis for an infrastructure development project. The route impact analysis may include determining the construction schedule, permits required, and labor costs for the infrastructure development along the route. The example method 700 includes receiving, by the GIS server, one or more route impact instructions from the user interface to provide a route impact analysis, as shown in block 702. The example method further includes processing, by the GIS server, route feature information to determine route impact of each route feature using a route impact analysis module, as shown in block 704. In addition the example method includes providing, by the GIS server, a route impact analysis report to the user interface using the route impact analysis module wherein the route impact analysis report includes the route impact for each route feature, as shown in block 706.

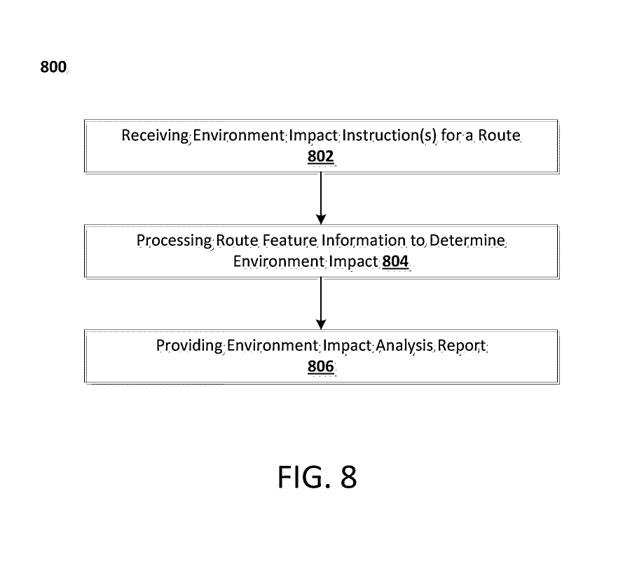

FIG. 8 is an example flowchart for an example method 800 for analyzing the environment impact of a route. Environment impact may include analyzing GIS layer data of the land surface and land subsurface along the route. For example, GIS layer data may be analyzed to determine whether a route traverses an underground water supply or whether there were other geological features that the route may impact (e.g. oil/gas reserve, arable land, forest preserve, etc.). Further, there may be man-made infrastructure (e.g. highways, roads, bridges, airports, etc.) that may be impacted by the route. The present disclosure discloses systems, methods, and devices that provide, dynamically and/or in real-time, a land use/environment analysis of traversing certain route features such as oil/gas reserve, arable land, forest preserve as well as highways, roads, bridges, airports, and other infrastructural route features. The land use/environment analysis may also analyze other route features that may be affected.

The example method 800 includes receiving, by the GIS server, one or more environment impact instructions from user interface to provide an environment impact analysis, as shown in block 802. The example method 800 further includes processing, by the GIS server, route feature information to determine environment impact of each route feature using the environment impact analysis module, as shown in block 804. In addition, the example method further includes providing an environment impact analysis report to the user interface using the environment impact analysis module wherein the environment impact analysis report includes the environment impact for each route feature, as shown in block 806.

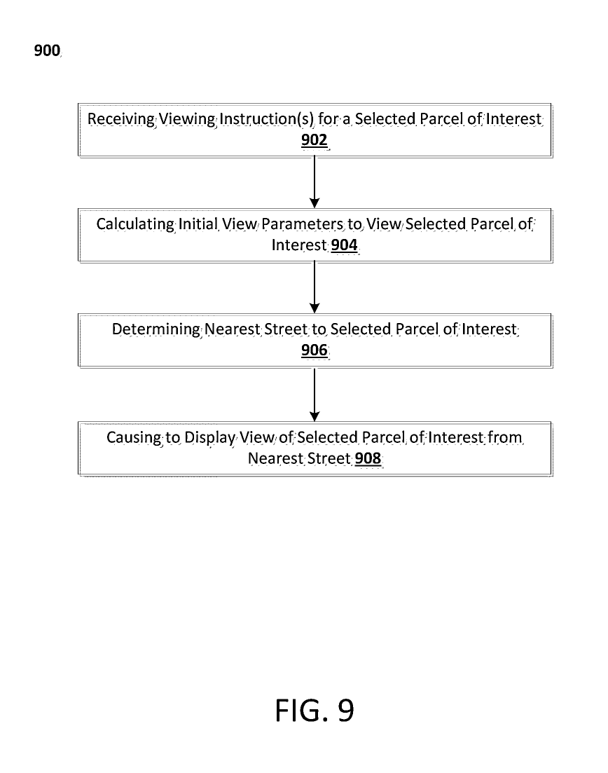

FIG. 9 is an example flowchart for an example method 900 to view a selected parcel of interest along a route. For example, a user may receive a cost analysis of a selected parcel of interest that at first glance seems high. The user may want to view the selected parcel of interest to determine whether there are unique aspects of the selected parcel of interest that may estimate the high cost. The example method includes receiving, by the GIS server and a viewing module, one or more viewing instructions from the user interface of the user computer to view a selected parcel of interest on the route, as shown in block 902. Further, the example method 900 includes calculating, by the GIS server and viewing module, one or more initial view parameters based on the selected parcel of interest, as shown in block 904. Initial view parameters may include the perspective and magnification to view the selected parcel of interest. In addition, the example method 900 includes determining a nearest street to the selected parcel of interest by the viewing module, as shown in block 906. Thus, a user may be able see the selected parcel of interest from the point of view of the nearest street. Moreover, the example method 900 includes causing to display, by the viewing module a view of the selected parcel of interest from the nearest street based on the initial view parameters on the user interface of the user computer, as shown in block 908.

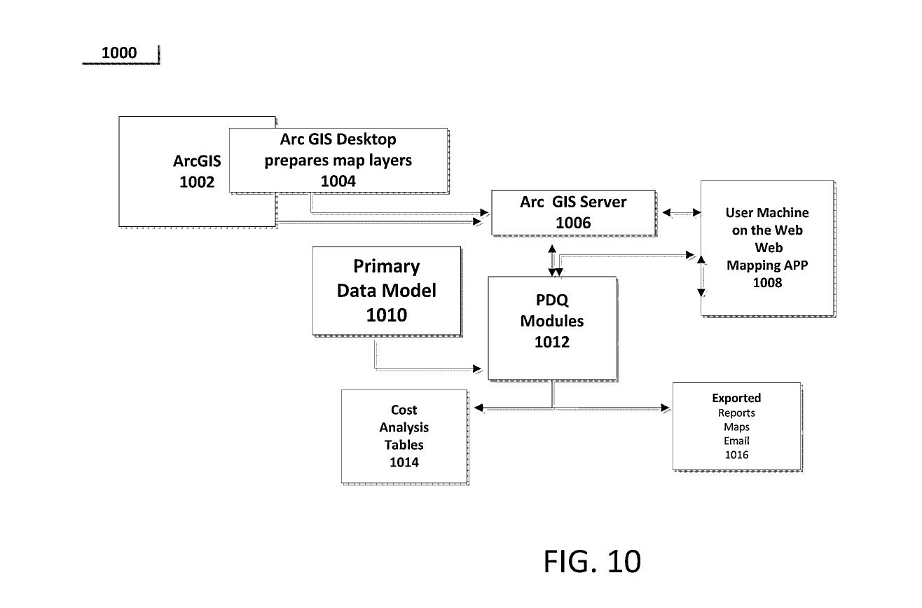

FIG. 10 is functional block diagram of an example functional architectural model 1000 for analyzing a route. The model 1000 shows an embodiment of the present disclosure that includes ArcGIS 1002 module that is a type of GIS engine module. Further, an Arc GIS Desktop module 1004 prepares map layer data that can be used to render maps on a user interface. Such functions (1002 and 1004) may be implemented by the Arc GIS server 1006. Further, PDQ modules 1012 include analytical modules (cost analysis module, route impact analysis module, and environment impact analysis module) as well as the route drawing module. A primary data model 1010 may be used in conjunction with the PDQ modules 1012. In addition, the PDQ modules may provide cost analysis tables 1014 or exports reports or maps via email 1016. A user at a user computer may access the Arc GIS 1002 and Arc GIS Desktop modules as well as the PDQ modules through a user interface.

The following description describes an embodiment of using the analytical modules (e.g. cost analysis module, route impact analysis module, and the environment analysis modules) and/or the route drawing module. The embodiment includes an Operating System (OS) that may be the underlying system that runs the software (e.g. Windows, OSX, Linux, Unix, etc.). Further, the embodiment includes a User Interface Builder (UIB) that can be Silverlight, Java, HTML, or an equivalent utility that can be used generate a screen on a web page. In addition, the embodiment includes a Web Browser module (e.g. Internet Explorer, Firefox, Safari or similar program, that when executed on a processor, provide a display used to view web pages). In addition, a GIS engine module may be ESRI's software ArcGIS™ Server that generates the information that the Browser uses to display the map, generates data sets that describe the intersection of features, and provides the map manipulation tools. A database module can be implemented using Oracle, SQL Server or any database supported by the GIS Engine. A GIS Server is a physical machine where the GIS Engine, Operating System and analytical, map rendering, and route drawing modules may be installed. A Map Service is a helper program that the GIS Engine module uses to create the data that the GIS Engine module sends to the Browser. A Valuation Service is, for example, Zillow, Core Logic, or a web site that can provide land values based on address or tax identification number. Further, the embodiment may include a viewing module may be Google Street View.

In order for analytical modules to work the following pre-requisite modules may need to be in place. An operating system (OS), database module, and GIS engine module need to be installed on a GIS Server. Further, the GIS Server is configured for communication across the Internet. In addition, the OS on the GIS Server must be configured to serve web pages. Moreover, the analytical modules are installed on/published to the GIS Server.

Additional prerequisite modules/ functions may include the appropriate Map Services that are created/installed on the GIS Server. For example, if the user desires information about land values a Map Service must be created which will return information related to land parcels. This may include a tax identification number, address, possibly owner information, etc.

In another embodiment, the user enters the URL into a browser and the GIS Server invokes one or more analytical modules or a route drawing module. Further, a user interface builder UIB (e.g. Silverlight, Java, HTML, or an equivalent utility that can generate a screen on a web page) informs the browser of the necessary plug-ins. In addition, the Browser verifies that the plug-ins are installed and if not, prompts the user to install the necessary plug-ins. Once the necessary plug-ins are installed, the analytical modules or route drawing module determine which Map Services are necessary, polls the GIS Engine for the appropriate data using the Map Services, and sends the data to the Browser to be rendered (drawn). At this point a user can see the screen on the browser module and can interact with the user interface and map. A user can pan and zoom in and out of the map using the tools built-in to the GIS Engine module. These modules are activated using buttons created on the screen by the UIB. To launch one of the analytical or route drawing modules a user clicks on the appropriate icon on the browser/user interface. The analytical or route drawing modules may then inform the UIB of the appropriate screen (dialog box) to display and the Browser renders the image (e.g., a dialog box). The user may then select a route drawing module from the dialog box by clicking on the appropriate icon. The route drawing module sends data to the GIS Engine telling it which type of line to draw for the route. As the user draws the line the data is sent to the GIS Engine module informing it of the characteristics of the route (route parameters). The GIS Engine also sends data back to the Browser module telling the browser how to render the route. The Browser renders the route on the screen.

After the user plots the route, the user may enter parameters for the line (width, etc.) into the dialog box. After entering all the appropriate parameters the user clicks on a “Calculate” button.

The analytical modules extract the parameters from the user interface module and send a query to the GIS Engine module to retrieve data about the affected features. The analytical modules also tell the GIS Engine module to return data to the Browser module to highlight the affected features. In the case of the Calculation Tool the GIS Engine module is asked to return the tax identification numbers and addresses of land parcels.

Once the GIS Engine module returns the data regarding the affected features the analytical modules performs calculations on the returned data. In the case of the Calculation functions the analytical modules calculates the total area of the affected parcels, the actual area affected based on parameters entered into the dialog box, the number of parcels affected.

The analytical modules then perform other specialized functions to calculate costs. In the case of the Calculation functions the analytical modules takes the address or tax identification number returned from the GIS Engine module and creates a query to a Valuation Service to obtain the value of the parcel. Then the analytical modules calculate a cost for the parcel based on the value of the entire parcel and the percentage of the parcel that is going to be affected. The analytical modules then create summary and detail reports passing data to the UIB.

The foregoing is illustrative only and is not intended to be in any way limiting. Reference is made to the accompanying drawings, which form a part hereof. In the drawings, similar symbols typically identify similar components, unless context dictates otherwise.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a module through volatile or non-volatile memory. Also, the hardware objects could communicate using electrical signals, with states of the signals representing different data.

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed:

1. A method comprising:
receiving one or more map display instructions from a user interface to display a map using a geographic information system (GIS) engine module and a map rendering module implemented by a GIS server;
requesting, by the GIS server, the GIS engine module to cause the map to be displayed on the user interface;
receiving, by the GIS server, one or more route display instructions from the user interface to cause to display a route on the map on the user interface by a route drawing module;
receiving, by the GIS server, one or more cost analysis instructions to determine the cost for the route from the user interface;
processing, by the GIS server, the route on the map and one or more route parameters using a cost analysis module to determine one or more route features and one or more land parcels;
querying, by the GIS server, the GIS engine module for route feature information and land parcel information and querying one or more valuation service servers to determine the cost associated with one or more route features and the one or more land parcels based on the route feature information and land parcel information;
calculating, using the cost analysis module, the cost of the route based on the cost associated with the one or more route features and one or more land parcels to provide a cost analysis of the route to the user interface.

2. The method of claim 1, further comprising:
receiving, by the GIS server, one or more route impact instructions from the user interface to provide a route impact analysis;
processing, by the GIS server, route feature information to determine route impact of each route feature using a route impact analysis module;
providing, by the GIS server, a route impact analysis report to the user interface using the route impact analysis module wherein the route impact analysis report includes the route impact for each route feature.

3. The method of claim 1, further comprising:
receiving, by the GIS server, one or more environment impact instructions from user interface to provide an environment impact analysis;
processing, by the GIS server, route feature information to determine environment impact of each route feature using the environment impact analysis module;
providing an environment impact analysis report to the user interface using the environment impact analysis module wherein the environment impact analysis report includes the environment impact for each route feature.

4. The method of claim 1, further comprising
receiving, by the GIS server and a viewing module, one or more viewing instructions from the user interface to view a selected parcel of interest on the route;
calculating, by the GIS server and the viewing module, one or more initial view parameters based on the selected parcel of interest
determining a nearest street to the selected parcel of interest and the viewing module;
causing to display, by the viewing module, a view of the selected parcel of interest from the nearest street based on the initial view parameters on the user interface.

5. The method of claim 1, further comprising retrieving, by the GIS engine module, the map from a database module to display on the user interface.

6. The method of claim 1, further comprising:
retrieving one or more GIS layer data associated with the route from the database module by the GIS engine module;
processing the one or more GIS layer data by the GIS engine module to determine the one or more route features and one or more land parcels of the route.

7. The method of claim 6, further comprising retrieving route feature information of the one or more route features from the database module.

8. A geographic information system (GIS) server, comprising:
a GIS engine module;
a cost analysis module;
a map rendering module;
a route drawing module;
one or more processors the one or more processors configured to:
receive one or more map display instructions from a user interface to display a map on the user interface using the GIS engine module and the map rendering module;
request the GIS engine module for the map to cause the map to be displayed on the user interface;
receive one or more route display instructions from the user interface to cause to display a route on the map on the user interface by the route drawing module;
receive one or more cost analysis instructions to determine the cost for the route from the user interface;
process the route on the map and one or more route parameters using the cost analysis module to determine one or more route features and one or more land parcels;
query the GIS engine module for route feature information and land parcel information and query one or more valuation service servers to determine the cost associated with the one or more route features and the one or more land parcels based on the route feature information and land parcel information;
calculate, using the cost analysis module, the cost of the route based on the cost associated with one or more route features and one or more land parcels to provide a cost analysis of the route to the user interface.

9. The GIS server of claim 8, further comprising:
a route impact analysis module;
wherein the one or more processors are further configured to:
receive one or more route impact instructions from user interface to provide a route impact analysis;
process route feature information to determine route impact of each route feature using the route impact analysis module;
provide a route impact analysis report to the user interface using the route impact analysis module wherein the route impact analysis report includes the route impact for each route feature.

10. The GIS server of claim 8, further comprising:
an environment impact analysis module;
wherein the one or more processors, using the GIS engine module and the environment impact analysis module are further configured to:
receive one or more environment impact instructions from user interface to provide an environment impact analysis;
process route feature information to determine environment impact of each route feature;
provide an environment impact analysis report to the user interface wherein the environment impact analysis report includes the environment impact for each route feature.

11. The GIS server of claim 8, wherein the one or more processors are further configured to:
receive one or more viewing instructions from the user interface to view a selected parcel of interest on the route;
calculate one or more initial view parameters based on the selected parcel of interest;
determine a nearest street to the selected parcel of interest;
causing to display a view of the selected parcel of interest from the nearest street based on the initial view parameters on the user interface.

12. The GIS server of claim 8, further comprising a database module coupled to a GIS engine module, the database module having one or more maps and one or more GIS layer data for each of the one or more maps.

13. The GIS server of claim 12, wherein the one or more processors are further configured to retrieve, by the GIS engine module, the map from the database module to display on the user interface.

14. The GIS server of claim 12, wherein the one or more processors are further configured to:
retrieve one or more GIS layer data associated with the route from the database module by the GIS engine module;
process the one or more GIS layer data by the GIS engine module to determine the one or more route features and one or more land parcels of the route.

15. The GIS server of claim 12, further comprising retrieving route feature information of the one or more route features from the database module.

16. A system, comprising:
a communication network;
a user interface coupled to the communication network;
a geographic information system (GIS) server coupled to the user interface over the communication network, the GIS server having:
a GIS engine module;
a cost analysis module;
a map rendering module;
a route drawing module;
one or more processors the one or more processors configured to:
receive one or more map display instructions from the user interface to display a map on the user interface using the GIS engine module and the map rendering module;
request the GIS engine module for the map to provide the map to be displayed on the user interface;
receive, by the GIS server, one or more route display instructions from the user interface to cause to display a route on the map on the user interface by the route drawing module;
receive, by the GIS server, one or more cost analysis instructions to determine the cost for the route from the user interface;
process the route on the map and one or more route parameters using the cost analysis module to determine one or more route features and one or more land parcels;
query the GIS engine module for route feature information and land parcel information and query one or more valuation service servers to determine the cost associated with the one or more route features and the one or more land parcels based on the route feature information and land parcel information;
calculate, using the cost analysis module, the cost of the route based on the cost of the one or more route features and one or more land parcels to provide a cost analysis of the route to the user interface.

17. The system of claim 16, further comprising:
a route impact analysis module;
wherein the one or more processors are further configured to:
receive one or more route impact instructions from user interface to provide a route impact analysis;
process route feature information to determine route impact of each route feature using the route impact analysis module;
provide a route impact analysis report to the user interface using the route impact analysis module wherein the route impact analysis report includes the route impact for each route feature.

18. The system of claim 16, further comprising:
an environment impact analysis module;
wherein the one or more processors, using the GIS engine module and the environment impact analysis module are further configured to:
receive one or more environment impact instructions from user interface to provide an environment impact analysis;
process route feature information to determine environment impact of each route feature;
provide an environment impact analysis report to the user interface wherein the environment impact analysis report includes the environment impact for each route feature.

19. The system of claim 14, wherein the one or more processors are further configured to:
receive one or more viewing instructions instruction from the user interface to view a selected parcel of interest on the route;
calculate one or more initial view parameters based on the selected parcel of interest;
determine a nearest street to the selected parcel of interest;
causing to display a view of the selected parcel of interest from the nearest street based on the initial view parameters on the user interface.

20. The system of claim 16 further comprising a database module coupled to a GIS engine module, the database module having one or more maps and one more GIS layer data for each of the one or more maps.

21. The system of claim 20, wherein the one or more processors are further configured to retrieve, by the GIS engine module, the map from the database module to display on the user interface.

22. The GIS server of claim 20, wherein the one or more processors are further configured to:
retrieve one or more GIS layer data associated with the route from the database module by the GIS engine module;
process the one or more GIS layer data by the GIS engine module to determine the one or more route features and one or more land parcels of the route.

23. The system of claim 20, further comprising retrieving route feature information of the one or more route features from the database module.

24. A method comprising:
receiving one or more map display instructions from a user interface to display a map using a map rendering module;
querying, by the map rendering module, a GIS engine module for data associated with the map;
causing to display, by the map rendering module, the map on the user interface;
receiving one or more route display instructions from the user interface to cause to display a route on the map on the user interface by a route drawing module;
causing to display, by the route drawing module, a route on the map displayed on the user interface;
receiving, by a cost analysis module, one or more cost analysis instructions to determine the cost for the route from the user interface;
processing, by cost analysis module, the route on the map and one or more route parameters using a cost analysis module to identify one or more route features and one or more land parcels;
querying, by the cost analysis module, the GIS engine module for route feature information and land parcel information and querying one or more valuation service servers to determine the cost associated with one or more route features and the one or more land parcels based on the route feature information and land parcel information;
calculating, using the cost analysis module, the cost of the route based on the cost associated with the one or more route features and one or more land parcels to provide a cost analysis of the route to the user interface.

25. The method of claim 24, further comprising:
receiving, by route impact module, one or more route impact instructions from the user interface to provide a route impact analysis;
processing route feature information to determine route impact of each route feature using a route impact analysis module;
providing a route impact analysis report to the user interface using the route impact analysis module wherein the route impact analysis report includes the route impact for each route feature.

26. The method of claim 24, further comprising:
receiving, by an environment impact analysis module, one or more environment impact instructions from user interface to provide an environment impact analysis;
processing route feature information to determine environment impact of each route feature using the environment impact analysis module;
providing an environment impact analysis report to the user interface using the environment impact analysis module wherein the environment impact analysis report includes the environment impact for each route feature.

27. The method of claim 24, further comprising
receiving, by a viewing module, one or more viewing instructions from the user interface to view a selected parcel of interest on the route;
calculating, by the viewing module, one or more initial view parameters based on the selected parcel of interest
determining a nearest street to the selected parcel of interest by the viewing module;
causing to display, by the viewing module, a view of the selected parcel of interest from the nearest street based on the initial view parameters on the user interface.

28. The method of claim 24, further comprising causing the GIS engine module to retrieve, the map from a database module to display on the user interface.

29. The method of claim 24, further comprising:
causing the GIS engine module to retrieve one or more GIS layer data associated with the route from the database module;
processing the one or more GIS layer data to determine the one or more route features and one or more land parcels of the route.

30. The method of claim 28, further comprising retrieving route feature information of the one or more route features from the database module.

31. An article of manufacture including computer readable media with instructions encoded and stored thereon, the stored instructions, when executed causes the computer to perform the steps of:
receiving one or more map display instructions from a user interface to display a map using a map rendering module;
querying, by the map rendering module, a GIS engine module for data associated with the map;
causing to display, by the map rendering module, the map on the user interface;
receiving one or more route display instructions from the user interface to cause to display a route on the map on the user interface by a route drawing module;
causing to display, by the route drawing module, a route on the map displayed on the user interface;
receiving, by a cost analysis module, one or more cost analysis instructions to determine the cost for the route from the user interface;
processing, by cost analysis module, the route on the map and one or more route parameters using a cost analysis module to identify one or more route features and one or more land parcels;
querying, by the cost analysis module, the GIS engine module for route feature information and land parcel information and querying one or more valuation service servers to determine the cost associated with one or more route features and the one or more land parcels based on the route feature information and land parcel information;
calculating, using the cost analysis module, the cost of the route based on the cost associated with the one or more route features and one or more land parcels to provide a cost analysis of the route to the user interface.

32. The article of manufacture of claim 31, wherein the stored instructions, when executed causes the computer to further perform the steps of:
receiving, by route impact module, one or more route impact instructions from the user interface to provide a route impact analysis;
processing route feature information to determine route impact of each route feature using a route impact analysis module;
providing a route impact analysis report to the user interface using the route impact analysis module wherein the route impact analysis report includes the route impact for each route feature.

33. The article of manufacture of claim 31, wherein the stored instructions, when executed causes the computer to further perform the steps of:
receiving, by an environment impact analysis module, one or more environment impact instructions from user interface to provide an environment impact analysis;
processing route feature information to determine environment impact of each route feature using the environment impact analysis module;
providing an environment impact analysis report to the user interface using the environment impact analysis module wherein the environment impact analysis report includes the environment impact for each route feature.

34. The article of manufacture of claim 31, wherein the stored instructions, when executed causes the computer to further perform the steps of:
receiving, by a viewing module, one or more viewing instructions from the user interface to view a selected parcel of interest on the route;
calculating, by the viewing module, one or more initial view parameters based on the selected parcel of interest
determining a nearest street to the selected parcel of interest by the viewing module;
causing to display, by the viewing module, a view of the selected parcel of interest from the nearest street based on the initial view parameters on the user interface.

35. The article of manufacture of claim 31, wherein the stored instructions, when executed causes the computer to further perform the steps of causing the GIS engine module to retrieve, the map from a database module to display on the user interface.

36. The article of manufacture of claim 35, wherein the stored instructions, when executed causes the computer to further perform the steps of:
causing the GIS engine module to retrieve one or more GIS layer data associated with the route from the database module;
processing the one or more GIS layer data to determine the one or more route features and one or more land parcels of the route.

37. The article of manufacture of claim 35, wherein the stored instructions, when executed causes the computer to further perform the steps of retrieving route feature information of the one or more route features from the database module.
